(19) United States
(12) Patent Application Publication
(10) Pub. No.: US 2014/0346898 A1
(43) Pub. Date: Nov. 27, 2014

(54) JUNCTION BOX HAVING THE MPPT CONTROL FUNCTION THAT IS INDIVIDUALLY EMBEDDED IN A SOLAR CELL MODULE, AND METHOD FOR DRIVING SAME

(71) Applicants: Yun Heui HAN, (US); CONNEX ELECTRONICS CO., LTD, Ansan-si, Gyeonggi-do (KR)

(72) Inventors: Yun Heui Han, Seoul (KR); Yong Soo Yoon, Seoul (KR)

(21) Appl. No.: 14/363,813

(22) PCT Filed: Nov. 14, 2012
(86) PCT No.: PCT/KR2012/009579

§ 371 Date: Jun. 9, 2014

(30) Foreign Application Priority Data
Dec. 7, 2011 (KR) 10-2011-0130487

(51) Int. Cl. H02J 1/10; G05F 5/00

(52) U.S. Cl. CPC H02J 1/102; G05F 5/00
USPC 307/151; 324/72

(57) ABSTRACT

Disclosed is a junction box which includes voltage and current sensors that are connected to both ends of bypass diodes provided within the junction box to sense currents and voltages of the solar cell module; a MPPT controller that tracks a maximum power point from current and voltage values sensed from the voltage and current sensors; and a voltage controller that includes a switch for controlling an operation of the solar cell module, and controls a voltage corresponding to the tracked maximum power point to be output.

### TECHNICAL FIELD

The present invention relates to a junction box having a MPPT control function that is individually embedded in a solar cell module and a method for driving the same, and more particularly, to a junction box that is connected to a solar cell module to transmit a power to an external module, and a method for driving a solar cell module using the same.

### BACKGROUND ART

A solar cell module includes a plurality of cells, and absorbs sunlight to produce a power. The power produced in the solar cell module is transmitted to a separate inverter at the outside through an embedded junction box, and the inverter converts the power into an AC power to supply the converted AC power to an external module. Here, the external module may correspond to various electronic devices (for example, a LED module) having an AC voltage as a driving source. A configuration example of the junction box is disclosed in Korean Patent Publication No. 10-2010-0117541 filed by the present applicant.

In general, performance of the solar cell module is largely affected by quantity of solar radiation or a temperature change, and as the temperature is increased, efficiency may be decreased. This is related with a general characteristic of a semiconductor. When voltage and current characteristics are changed depending on an environment such as temperature, a power scale determined by multiflying a current and a voltage is also changed. Accordingly, in order to optimally maintain the performance of the solar cell module, it is necessary to control an output to be a voltage that can produce a maximum power amount.

In addition, in the related art, an output power amount of the solar cell module is collectively controlled through a single power control unit connected to both string ends of solar cell modules. FIG. 1 is a schematic diagram illustrating a control configuration of a solar cell module according to the related art.

A power control unit 1 according to the related art is connected to both string ends of several solar cell modules 2 to control outputs of the solar cell modules 2 to be the same optimal power. By doing this, since the voltage is controlled for each string other than each module, it may be difficult to individually control the solar cell modules, and it is difficult to easily check a module having a problem such as a malfunction. That is, according to the related art, it may be difficult to individually perform maintenance for the solar cell modules.

### DISCLOSURE

### Technical Problem

An object of the present invention is to provide a junction box having a MPPT control function that is individually embedded in a solar cell module and a method for driving the same, with which it is possible to individually control outputs by using a voltage corresponding to a maximum power point by providing a MPPT function to the junction box connected to the solar cell module and tracking a maximum power point from sensed current and voltage values of the solar cell module.

### Technical Solution

An exemplary embodiment of the present invention provides a junction box having a MPPT control function that is individually embedded in a solar cell module including a plurality of cells. The junction box includes voltage and current sensors that are connected to both ends of bypass diodes provided within the junction box to sense currents and voltages of the solar cell module; a MPPT controller that tracks a maximum power point from current and voltage values sensed from the voltage and current sensors; and a voltage controller that includes a switch for controlling an operation of the solar cell module, and controls a voltage corresponding to the tracked maximum power point to be output.

Here, the junction box may further include a temperature sensor that is provided at a connected portion with the solar cell module within the junction box to sense a temperature of the solar cell module. When the sensed value of the temperature sensor exceeds a reference value, the voltage controller may turn off the switch.

Further, the junction box may further include a wireless transmitting unit that wirelessly transmits the sensed values of the temperature sensor and the voltage and current sensors to a control server.

Furthermore, another exemplary embodiment of the present invention provides a method for assigning an ID to a solar cell module including the junction box. The method includes sensing a signal of a current or a voltage flowing in the solar cell when an ID assigning module is connected to both ends of output terminals of the junction box; transmitting the sensed signal to an external control server; receiving an ID corresponding to the electrical signal from the control server; and storing the received ID in the MPPT controller.

Moreover, still another exemplary embodiment of the present invention provides a junction box having a MPPT control function that is individually embedded in a solar cell module including a plurality of cells. The junction box includes voltage and current sensors that are connected to both ends of bypass diodes provided within the junction box to sense currents and voltages of the solar cell module; a temperature sensor that senses a temperature of the solar cell module within the junction box; a DB that stores an optimal voltage value for outputting a maximum power point per current for each temperature; a MPPT controller that extracts the optimal voltage value corresponding to the sensed values from the voltage and current sensors and the temperature sensor from the DB; and a voltage controller that includes a switch for controlling an operation of the solar cell module, and controls the extracted optimal voltage to be output.

Here, when a sensed value of the temperature sensor exceeds a reference value, the voltage controller may turn off the switch.

In addition, still another exemplary embodiment of the present invention provides a method for assigning an ID to a solar cell module including the junction box. The method includes sensing a signal of a current or a voltage flowing in the solar cell when an ID assigning module is connected to both ends of output terminals of the junction box; transmitting the sensed signal to an external control server; receiving an ID corresponding to the electrical signal from the control server; and storing the received ID in the MPPT controller.

Furthermore, still another exemplary embodiment of the present invention provides a method for driving a solar cell module including a plurality of cells by using a junction box having a MPPT control function that is individually embedded in the solar cell module. The method includes sensing current and voltage values of the solar cell module through voltage and current sensors connected to both ends of bypass diodes provided within the junction box; tracking a maximum power point from the received values through a MPPT controller that receives the sensed current and voltage values; and controlling a voltage corresponding to the maximum power point to be output through a voltage controller including a switch for controlling an operation of the solar cell module.

Here, the driving method may further include sensing a temperature value of the solar cell module through a temperature sensor provided at a connected portion with the solar cell module within the junction box; and turning off the switch by the voltage controller when the sensed value of the temperature sensor exceeds a reference value.

Moreover, the driving method may further include transmitting the sensed values of the temperature sensor and the voltage and current sensors to a control server in a wireless manner.

In addition, still another exemplary embodiment of the present invention provides a method for driving a solar cell module including a plurality of cells by using a junction box having a MPPT control function that is individually embedded in the solar cell module. The method includes sensing current and voltage values of the solar cell module through voltage and current sensors connected to both ends of bypass diodes provided within the junction box; sensing a temperature value of the solar cell module through a temperature sensor provided at a connected portion with the solar cell module within the junction box; extracting an optimal voltage value corresponding to the sensed values from the voltage and current sensors and the temperature sensor through a MPPT controller from a DB that stores the optimal voltage value for outputting a maximum power point per current for each temperature; and controlling the extracted optimal voltage value to be output through a voltage controller including a switch for controlling an operation of the solar cell module.

Here, the driving method may further include turning off the switch by the voltage controller when the sensed value of the temperature sensor exceeds a reference value.

### Advantageous Effects

In accordance with a junction box having a MPPT control function that is individually embedded in a solar cell module and a method for driving the same, since a MPPT function is provided to the junction box connected to the solar cell module and a maximum power point is tracked from sensed current and voltage values of the solar cell module, outputs of output terminals are controlled using a voltage corresponding to the maximum power point. Accordingly, it is possible to optimize power producing efficiency of the solar cell module and to individually perform maintenance for the solar cell modules.

### DESCRIPTION OF DRAWINGS

FIG. 1 is a schematic diagram illustrating a control configuration of a junction box according to the related art.

FIG. 2 is a schematic diagram of a junction box having a MPPT control function according to an embodiment of the present invention.

FIG. 3 is a detailed configuration diagram of the junction box of FIG. 2.

FIG. 4 is a reference diagram for describing MPPT control by a MPPT controller of FIG. 3.

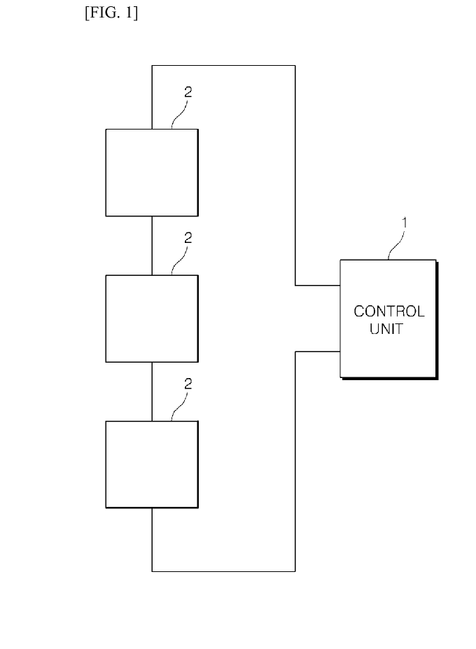

### BEST MODE

Hereinafter, embodiments of the present invention will be described in detail with reference to the accompanying drawings to allow those skilled in the art to easily implement the embodiments.

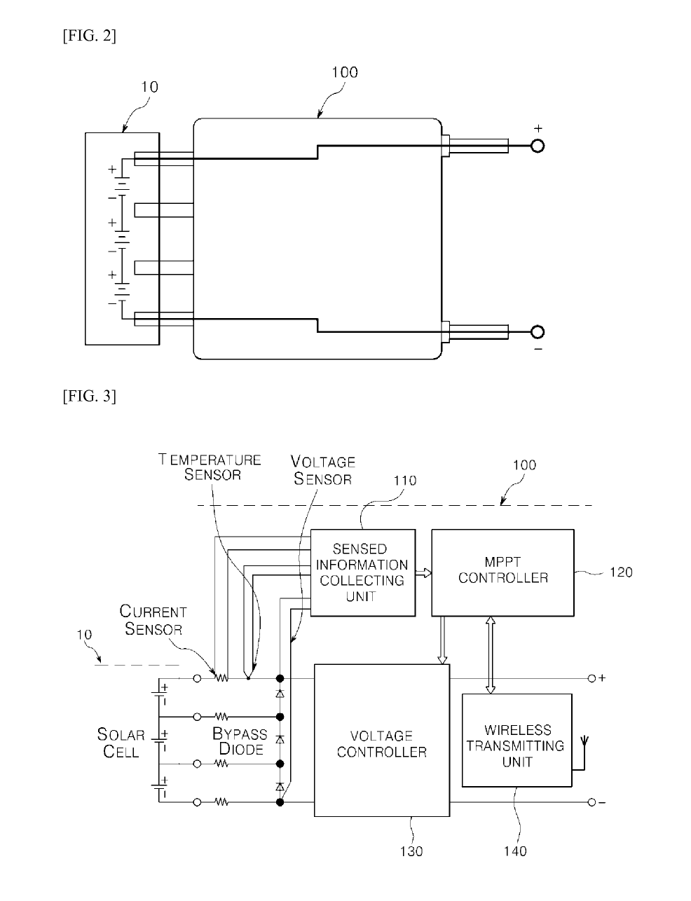

FIG. 2 is a schematic diagram of a junction box having a MPPT control function according to an embodiment of the present invention.

A solar cell module 10 including a plurality of cells is connected onto a left side of the junction box 100. Further, an external module (not illustrated) may be separately connected between output terminals, that is, a + terminal and a − terminal on a right side of the junction box 100. The junction box 100 serves to transmit a power generated from the solar cell module 10 to the external module through the output terminals. Here, the external module may correspond to various electronic devices that are driven by receiving the power. FIG. 2 is a diagram in which an internal configuration of the junction box 100 is not illustrated, and more detailed configuration thereof refers to Korean Patent Publication No. 10-2010-0117541 filed by the present applicant.

FIG. 3 is a detailed configuration diagram of the junction box of FIG. 2. The junction box 100 includes a sensed information collecting unit 110, a MPPT controller 120, a voltage controller 130, and a wireless transmitting unit 140. Here, the sensed information collecting unit 110 includes voltage and current sensors, and a temperature sensor.

The voltage and current sensors are connected to both ends of bypass diodes provided within the junction box 100 to sense currents and voltages of the solar cell module 10. The voltage sensor refers to a connection portion of a voltage sensor of FIG. 3.

Here, although it has been illustrated in the embodiment of FIG. 3 that the current is sensed at both ends of a resistor (see a current sensor of FIG. 3), the current may be sensed at an arbitrary portion of a circuit, and the present invention is not necessarily limited thereto. In other words, the embodiment of FIG. 3 corresponds to an embodiment in which voltages are sensed from both ends of diodes and currents are measured from both ends of resistors, and measurement points of the voltages and currents are not necessarily limited thereto.

The temperature sensor is provided at a connected portion with the solar cell module 10 within the junction box 100 to sense a temperature of the solar cell module 10. Such a temperature sensor refers to a connection portion of a temperature sensor of FIG. 3. Here, a measurement point of the temperature sensor is not necessarily limited to the embodiment of FIG. 3.

The MPPT controller 120 is a part that tracks a maximum power point from current and voltage values sensed from the voltage and current sensors. This is performed by a MPPT (Maximum Power Point Tracking) method. Further, the voltage controller 130 includes a switch (not illustrated) that controls an operation of the solar cell module 10, and controls a voltage corresponding to the tracked maximum power point to be output between the output terminals (between the + terminal and the − terminal of the junction box 100) of the junction box 100. The voltage can be controlled through the switch.

That is, unlike an existing solar cell module, in the present invention, since the MPPT function is embedded in each of junction boxes that are connected to solar cell modules in one-to-one correspondence, it is possible to individually perform maintenance for the solar cell modules and individually monitor the solar cell modules. Moreover, it is possible to control each of the modules. In other words, the MPPT-embedded junction box is individually (independently) provided within the solar cell module, so that it is possible to easily perform maintenance for the modules by individually control each of the modules, and it is possible to improve power producing efficiency.

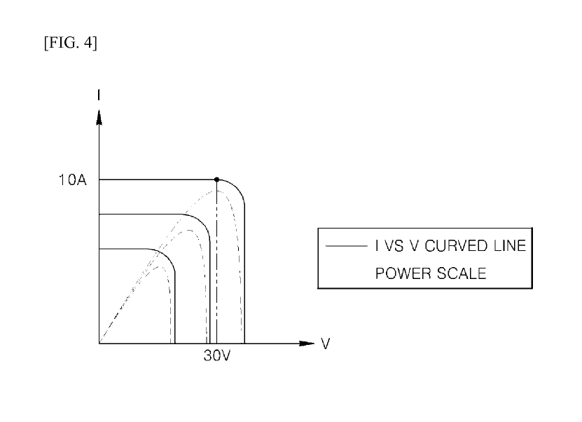

Hereinafter, a method for controlling the MPPT by the MPPT controller 120 will be described in detail. FIG. 4 is a reference diagram for describing MPPT control by the MPPT controller of FIG. 3.

FIG. 4 schematically illustrates characteristics of current vs voltage curved lines (solid lines) in a semiconductor, and illustrates examples of curved lines for three different temperature conditions. Here, the temperature corresponds to quantity of solar radiation. Furthermore, dotted lines depict power scale curved lines correponding to the respective curved lines, and are determined by multiplying voltages and currents.

Referring to FIG. 4, in all temperature conditions, curved lines show that when the voltages are increased to some extent, the currents are sharply decreased. For example, it can be seen that a current value is sharply decreased from a point P of 30 V at a current of 10 A. The power scale is also sharply decreased along with a decrease of the current value.

In order to increase power outputting efficiency of the solar cell module 10, it is controlled such that a maximum power point is tracked in the graph of FIG. 4 and a voltage corresponding to the maximum power point can be output from output terminals. The maximum power point corresponds to a point of the largest value among values obtained by multiplying the sensed voltages and currents.

To achieve this, by referring to the voltage and the current that are sensed and monitored in real time, the voltage controller 130 controls output voltages of the output terminals of the junction box 100 by using the voltage value corresponding to the maximum power point, so that it is possible to optimize the power producing efficiency of the solar cell module 10. Here, the voltage corresponding to the maximum power point may correspond to the voltage value corresponding to the point P before the current value is sharply decreased. Naturally, by calculating power values by multiplying the voltages and the currents that are measured in real time, a power having the maximum value and a voltage corresponding to the power having the maximum value can be accurately checked.

Moreover, when the sensed value of the temperature sensor exceeds a reference value, the voltage controller 130 turns off the switch within the voltage controller 130. Depending on the turning off operation, an operation of an internal circuit of the voltage controller 130 may be blocked to block power transmission to the outside or to block driving of the solar cell module 10.

For example, when the currently sensed temperature value is abnormal, the switch is turned off, so that it is possible to block the power supply to the external module. That is, when an output characteristic of the solar cell module 10 is varied by a temperature greater than the reference value, a performance problem of the external module that is operated by receiving the power from the solar cell module 10 may be caused, or the external module may be damaged. In the present invention, such problems can be solved through the voltage controller 130.

The wireless transmitting unit 140 serves to wirelessly transmit the sensed values of the temperature sensor and the voltage and current sensors to a control server (not illustrated). The solar cell module 10 can be monitored and analyzed in real time by using information transmitted to the control server, and the information can be used as reference data for analyzing problems by inquiring into the history. That is, the control server wirelessly receives the measured sensed values from the plurality of junction boxes 140 and collects the received values, so that it is easy to individually monitor the modules and to individually perform maintenance for the modules.

Here, by assigning a unique ID to each junction box (corresponding to each solar cell module), it is possible to easily identify the solar cell module and manage data. A method for assigning the unique ID is as follows.

Firstly, before the external module is connected to the both ends of the output terminals of the junction box 100, a separate ID assigning module (not illustrated) is connected to the both ends (between the + terminal and the − terminal) of the output terminals. When the ID assigning module is connected, the wireless transmitting unit 140 senses an arbitrary current or voltage signal flowing in the solar cell. Naturally, such an operation may be assisted by the MPPT controller 120. Here, the ID assigning module acts as a load of the junction box 100, and the voltage or the current can be naturally measured when the load is connected.

Subsequently, the wireless transmitting unit 140 transmits the sensed signal to the external control server. Here, when the sensed signal is transmitted, the sensed signal may be transmitted through a separate PC, smartphone or mobile phone.

At this time, the control server generates an ID corresponding to the sensed signal. For example, when the sensed signal is firstly received from the first junction box 100 among the plurality of junction boxes 100, the control server generates a corresponding ID (for example, an ID‘1’) and transmits the generated ID to the wireless transmitting unit 140 of the first junction box 100. In addition, when the sensed signal is firstly received from the third junction box 100, the ID‘1’ may be assigned to the third junction box 100.

In this way, when the ID corresponding to the electrical signal is received from the control server, the received ID is stored in a microcomputer of the MPPT controller 120 and is managed as its own ID. Thereafter, whenever the wireless transmitting unit 140 transmits the sensed values of the voltage, current and temperature to the control server, the wireless transmitting unit transmits the sensed values in association with the previously assigned ID, so that it is possible to increase data managing and operating efficiency.

The method for controlling the solar cell module according to the embodiment of the present invention described above is briefly described as follows. Firstly, the voltage and current sensors sense the current and voltage values of the solar cell module 10. Subsequently, the MPPT controller 120 tracks the maximum power point from the sensed current and voltage values. Thereafter, the voltage controller 130 controls the voltage corresponding to the maximum power point to be output through the output terminals.

Moreover, the temperature value of the solar cell module 10 is sensed in real time through the temperature sensor. At this time, when the sensed value of the temperature sensor exceeds the reference value, the switch within the voltage controller 130 is turned off.

In the embodiment, the maximum power point is directly tracked from the voltage and current values that are sensed in real time. Unlike the embodiment, another embodiment in which the maximum power point is tracked using DB information stored in advance will be described below.

To achieve this, the junction box 100 includes a separate DB (not illustrated). The DB may be included in the voltage controller 130, or may be separately provided from the voltage controller 130.

Optimal voltage values for outputting maximum power points for temperatures are previously stored in the DB. That is, the DB stores contents of FIG. 4.

In such a case, the MPPT controller 120 extracts, from the DB, an optimal voltage value corresponding to the sensed values from the voltage and current sensors and the temperature sensor. Subsequently, the voltage controller 130 controls the extracted optimal voltage value to be output from the output terminal. For example, when the currently sensed temperature and current values are known, the current and voltage curved line corresponding to the sensed value are found, and an optimal voltage value (for example, the voltage value corresponding to the point P corresponding to the maximum power point) for the curved line can be extracted.

The method for controlling the solar cell module according to another embodiment of the present invention described above is briefly described as follows. Firstly, the voltage and current sensors sense the current and voltage values of the solar cell module 10. Further, the temperature sensor senses the temperature value of the solar cell module 10.

Thereafter, the MPPT controller 120 extracts, from the DB, the optimal voltage value corresponding to the sensed values from the voltage and current sensors and the temperature sensor. Subsequently, the voltage controller 130 controls the extracted optimal voltage value to be output from the output terminals. Naturally, when the sensed value of the temperature sensor exceeds the reference value, the switch embedded in the voltage controller 130 may be turned off.

In accordance with the junction box and method for controlling the solar cell module according to the present invention described above, since the MPPT function is provided to the junction box connected to the solar cell module and the maximum power point is tracked from the sensed current and voltage values of the solar cell module, the outputs of the output terminals are controlled using the voltage corresponding to the maximum power point. Accordingly, it is possible to optimize the power producing efficiency of the solar cell module, and it is possible to individually perform maintenance for the solar cell modules and to monitor the solar cell modules.

Although the present invention has been described in connection with the embodiments illustrated in the drawings, the embodiments are merely examples. It should be understood to those skilled in the art that various modifications and equivalents to the embodiments are possible. Therefore, the technical scope of the present invention should be decided by the technical spirit of the appended claims.

1. A junction box having a MPPT control function that is individually embedded in a solar cell module including a plurality of cells, the junction box comprising:
voltage and current sensors that are connected to both ends of bypass diodes provided within the junction box to sense currents and voltages of the solar cell module;
a MPPT controller that tracks a maximum power point from current and voltage values sensed from the voltage and current sensors; and
a voltage controller that includes a switch for controlling an operation of the solar cell module, and controls a voltage corresponding to the tracked maximum power point to be output.

2. The junction box of claim 1, further comprising:
a temperature sensor that is provided at a connected portion with the solar cell module within the junction box to sense a temperature of the solar cell module,
wherein when the sensed value of the temperature sensor exceeds a reference value, the voltage controller turns off the switch.

3. The junction box of claim 2, further comprising:
a wireless transmitting unit that wirelessly transmits the sensed values of the temperature sensor and the voltage and current sensors to a control server.

4. A method for assigning an ID to a solar cell module including the junction box of claim 1, the method comprising:
sensing a signal of a current or a voltage flowing in the solar cell when an ID assigning module is connected to both ends of output terminals of the junction box;
transmitting the sensed signal to an external control server;
receiving an ID corresponding to the electrical signal from the control server; and
storing the received ID in the MPPT controller.

5. A junction box having a MPPT control function that is individually embedded in a solar cell module including a plurality of cells, the junction box comprising:
voltage and current sensors that are connected to both ends of bypass diodes provided within the junction box to sense currents and voltages of the solar cell module;
a temperature sensor that senses a temperature of the solar cell module within the junction box;
a DB that stores an optimal voltage value for outputting a maximum power point for each temperature;
a MPPT controller that extracts the optimal voltage value corresponding to the sensed values from the voltage and current sensors and the temperature sensor from the DB; and
a voltage controller that includes a switch for controlling an operation of the solar cell module, and controls the extracted optimal voltage to be output.

6. The junction box of claim 5, wherein when a sensed value of the temperature sensor exceeds a reference value, the voltage controller turns off the switch.

7. A method for assigning an ID to a solar cell module including the junction box of claim 5, the method comprising:
sensing a signal of a current or a voltage flowing in the solar cell when an ID assigning module is connected to both ends of output terminals of the junction box;
transmitting the sensed signal to an external control server;
receiving an ID corresponding to the electrical signal from the control server; and
storing the received ID in the MPPT controller.

8. A method for driving a solar cell module including a plurality of cells by using a junction box having a MPPT control function that is individually embedded in the solar cell module, the method comprising:
sensing current and voltage values of the solar cell module through voltage and current sensors connected to both ends of bypass diodes provided within the junction box;
tracking a maximum power point from the received values through a MPPT controller that receives the sensed current and voltage values; and
controlling a voltage corresponding to the maximum power point to be output through a voltage controller including a switch for controlling an operation of the solar cell module.

9. The method for claim 8, further comprising:
sensing a temperature value of the solar cell module through a temperature sensor provided at a connected portion with the solar cell module within the junction box; and
turning off the switch by the voltage controller when the sensed value of the temperature sensor exceeds a reference value.

10. The method for claim 9, further comprising:
transmitting the sensed values of the temperature sensor and the voltage and current sensors to a control server in a wireless manner.

11-12. (canceled)
